(19) United States
(12) Patent Application Publication
(10) Pub. No.: US 2016/0307142 A1
(43) Pub. Date: Oct. 20, 2016

(54) METHODS AND SYSTEMS FOR CREATING LOG OF ONE OR MORE EVENTS THROUGH CROWDSOURCING

(71) Applicant: XEROX CORPORATION, Norwalk, CT (US)

(72) Inventors: Jagadeesh Prabhakara, Chittoor (IN); Shailesh Vaya, Bangalore (IN); Chithralekha Balamurugan, Kamaraj Nagar (IN)

(21) Appl. No.: 14/687,093

(22) Filed: Apr. 15, 2015

(51) Int. Cl. G06Q 10/06; G06K 9/00

(52) U.S. Cl. CPC G06Q 10/063114; G06K 9/00771

(57) ABSTRACT

According to embodiments illustrated herein, a method and system is provided for creating a log of one or more events in a first multimedia content. The method includes transmitting, by a transceiver, the first multimedia content and a second multimedia content to a first set of workers. The first set of workers utilize the second multimedia content to identify the one or more events in the first multimedia content. The method further comprises creating, by one or more processors, the log of the one or more events, identified by the first set of workers, based on at least temporal occurrence of the one or more events in the first multimedia content.

### TECHNICAL FIELD

The presently disclosed embodiments are related, in general, to crowdsourcing. More particularly, the presently disclosed embodiments are related to methods and systems for creating log of one or more events through crowdsourcing.

### BACKGROUND

Recording and logging activities performed in an organization may be useful for analyzing business processes and determining areas of improvement of the organization. Typically, one or more employees of the organization may manually log such activities. With growth of operations of the organization, maintaining such logs manually may become cumbersome and the organization may have to use video surveillance for capturing and subsequently logging the various activities. However, analyzing a voluminous video footage generated through such video surveillance and generating a meaningful activity log therefrom may be a daunting task.

### SUMMARY

According to embodiments illustrated herein, there is provided a system for creating a log of one or more events in a first multimedia content. The system includes a transceiver configured to transmit the first multimedia content and a second multimedia content to a first set of workers. The first set of workers utilize the second multimedia content to identify the one or more events in the first multimedia content. The system further includes one or more processors configured to create the log of the one or more events, identified by the first set of workers, based on at least temporal occurrence of the one or more events in the first multimedia content.

According to embodiments illustrated herein, there is provided a method for creating a log of one or more events in a first multimedia content. The method includes transmitting, by a transceiver, the first multimedia content and a second multimedia content to a first set of workers. The first set of workers utilize the second multimedia content to identify the one or more events in the first multimedia content. The method further comprises creating, by one or more processors, the log of the one or more events, identified by the first set of workers, based on at least temporal occurrence of the one or more events in the first multimedia content.

According to embodiments illustrated herein, there is provided a method for determining a compliance of an execution of one or more processes/workflows in an organization. The method includes receiving, by a transceiver, a first multimedia content related to the execution of the one or more processes/workflows. The method further includes transmitting, the first multimedia content and a second multimedia content to a first set of workers by the transceiver. The first set of workers utilize the second multimedia content to identify one or more events, associated with the execution of the one or more processes/workflows, in the first multimedia content. The method further includes creating, by one or more processors, a log of the one or more events, identified by the first set of workers, based on at least temporal occurrence of the one or more events in the first multimedia content. Thereafter, a comparator compares the log with a predetermined standard of the execution of the one or more processes/workflows. Based on the comparison, the one or more processors determine the compliance of the execution of the one or more processes/workflows.

According to embodiments illustrated herein, there is provided a computer program product for use with a computing device. The computer program product includes a non-transitory computer readable medium. The non-transitory computer readable medium stores a computer program code for creating a log of one or more events in a first multimedia content. The computer program code is executable by one or more micro-processors in the computing device to transmit, by a transceiver, the first multimedia content and a second multimedia content to a first set of workers, wherein the first set of workers utilize the second multimedia content to identify the one or more events in the first multimedia content. The computer program code is further executable by the one or more processors to create the log of the one or more events, identified by the first set of workers, based on at least temporal occurrence of the one or more events in the first multimedia content.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a block diagram that illustrates a system configured for creating a log of one or more events in a first multimedia content, in accordance with at least one embodiment;

FIG. 3 is a flowchart illustrating a method for creating a log of one or more events in a first multimedia content, in accordance with at least one embodiment;

FIGS. 4A and 4B illustrate example user-interfaces that may be presented to a worker on the worker's computing device to display a second multimedia content to the worker, in accordance with at least one embodiment; and

FIG. 5 illustrates an example user-interface that may be presented to a worker on the worker's computing device to display a first multimedia content to the worker and receive inputs pertaining to an identification of one or more events in the first multimedia content, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

### DEFINITIONS

The following terms shall have, for the purposes of this application, the respective meanings set forth below.

“Crowdsourcing” refers to distributing tasks (hereinafter, also referred to as crowdsourcing tasks) by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk, Crowd Flower, or Mobile Works.

A “crowdworker” refers to a workforce/worker(s) who may perform one or more tasks that generate data that contributes to a defined result. With reference to the present disclosure, the crowdworker(s) includes, but is not limited to, a satellite center employee, a rural business process outsourcing (BPO) firm employee, a home-based employee, or an internet-based employee. Further, in an embodiment, the crowdworker may be an employee or a worker working for or hired by an organization, which crowdsources the one or more tasks. Hereinafter, the terms “crowdworker”, “worker”, “remote worker”, “crowdsourced workforce”, and “crowd” may be used interchangeably.

A “crowdsourcing task” refers to a piece of work, an activity, an action, a job, an instruction, or an assignment to be performed. Crowdsourcing tasks may necessitate the involvement of one or more workers. Examples of tasks may include, but are not limited to, an image/video/text labelling/tagging/categorization, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image analysis, directory compilation, or information search/retrieval.

A “multimedia content” refers to at least one of, but not limited to, audio, video, text, image, or animation. In an embodiment, the multimedia content may be played through a media player such as VLC Media Player, Windows Media Player, Adobe Flash Player, Apple QuickTime Player, etc., on a computing device. In an embodiment, the multimedia content may be downloaded or streamed from a multimedia server to the computing device. In an alternate embodiment, the multimedia content may be stored on a media storage device such as Hard Disk Drive, CD Drive, Pen Drive, etc., connected to (or inbuilt within) the computing device.

A “first multimedia content” refers to a multimedia content that captures one or more activities performed in an organization over a period of time. In an embodiment, the first multimedia content may be related to an execution of one or more processes/workflows in an organization. For example, if the organization is a hospital, a clinic, a trauma care center, or any health care provider, the first multimedia content may be related to providing healthcare services to one or more patients. The various processes in such an organization may include admission of the patients, diagnosis/treatment of the patients (such as OPD consulting, pre-operative care, post-operative care, etc.), surgery procedures, etc. If the organization is a print shop, the first multimedia content may be related to various processes involved in the print shop. Examples of such processes include, but are not limited to, purchase of raw materials (such as paper, flex, boards, plastics, ceramics, etc.), receipt of orders, set-up of the orders on print machines, processing of the orders on the print machines, delivery of the orders, maintenance and repair of the machines, and so on. Further, if the organization is a law enforcement agency or a security agency, the first multimedia content may include a video surveillance footage of a location of interest. In such a scenario, the processes related to the organization may include an enforcement of law and order in the location of interest or a security check of one or more objects or individuals.

A “second multimedia content refers to a multimedia content including an example illustration of one or more activities that may be captured in the first multimedia content. In an embodiment, the second multimedia content may include an animation illustrating the one or more activities. In an embodiment, the first and the second multimedia contents may be transmitted to a first set of workers, who may identify one or more events in the first multimedia content by utilizing the second multimedia content.

“Segregation” refers to a process of dividing or splitting a multimedia content into one or more multimedia snippets.

“One or more multimedia snippets” refer to one or more portions of the multimedia content. In an embodiment, the multimedia snippets may correspond to a set of frames or snapshots that are extracted from the multimedia content. In an embodiment, such frames or snapshots may be encoded in accordance to one or more encoding algorithms such as, but not limited to, MPEG4, AVI, etc.

An “entity representative of confidential/private information” refers to an object or an individual represented within the first multimedia content, such that revealing the entity as is, to an external user (e.g., a worker), may lead to a loss of confidential, private, or sensitive information related to the entity or an organization related to the entity. For example, the entity may include an individual such as an employee or a customer of the organization. In such a scenario, a facial region of the individual in the first multimedia content may reveal the identity of the individual and lead to a loss of confidentiality for the organization.

“Masking” refers to process of hiding a portion/region in one or more frames of the first multimedia content to preserve a privacy/confidentiality associated with one or more entities. For example, a facial region of one or more individuals in the first multimedia content may be masked to hide the identity of the one or more individuals.

An “object of interest” refers to an object or an individual which/who may be involved in one or more activities being captured by the first multimedia content. In an embodiment, one or more events may be identified as an interaction/association of one or more objects of interest.

“Marking” refers to a process of identifying one or more objects of interest in the first multimedia content.

An “activity” refers to one or more sequential actions/tasks being performed by a human entity or a machine entity to obtain a desired output. In an embodiment, an activity may involve use of one or more objects of interest. Further, the activity may be recorded in the first multimedia content. In an embodiment, an activity may be a time bound activity. For example, an activity may be performed only during a predetermined time period.

An “event” refers to an occurrence of a happening while performing an activity that may or may not involve a human entity. In an embodiment, an event may occur at a predetermined time instance. In an embodiment, a first set of workers may identify one or more events in the first multimedia content. In an embodiment, an event may be representative of a start, an end or an intermediate step of an activity in the first multimedia content.

“One or more attributes of an event” refer to one or more characteristics associated with the event. In an embodiment, the one or more attributes of an event may include, but are not limited to, a timestamp associated with the event, a tag associated with the event, a type of the event, one or more objects of interest involved in an activity associated with the event, or an identification of the event.

A “log” refers to a record of one or more events in a chronological order of their occurrence in the first multimedia content.

A “predetermined standard” refers to a standard against which a compliance of a processing of a task in an organization may be checked. In a scenario where the one or more events relate to an execution of one or more processes/workflows in an organization, in an embodiment, the log of the one or more events may be compared with the predetermined standard to determine the compliance of the execution of the one or more processes/workflows.

“Confidentiality criteria” refers to a set of conditions that may be checked to identify the one or more entities in the first multimedia content that include confidential/private information.

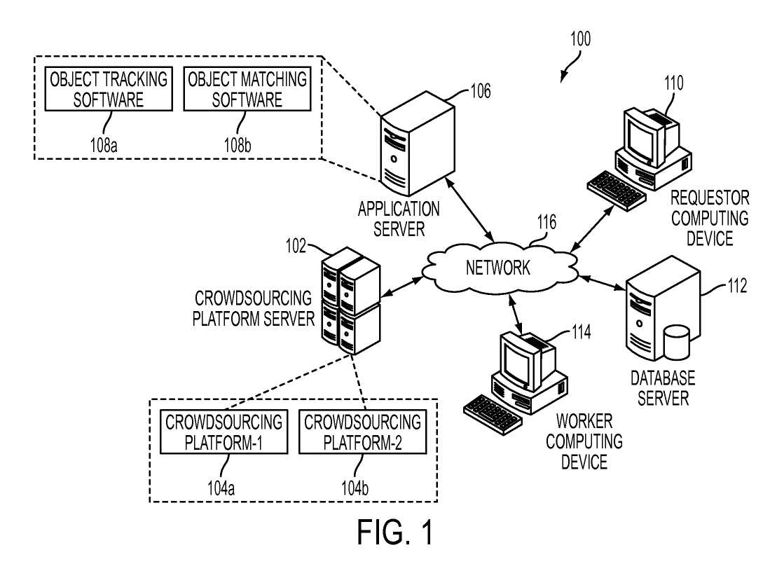

FIG. 1 is a block diagram of a system environment 100, in which various embodiments can be implemented. The system environment 100 includes a crowdsourcing platform server 102, an application server 106, a requestor-computing device 110, a database server 112, a worker-computing device 114, and a network 116.

In an embodiment, the crowdsourcing platform server 102 is configured to host one or more crowdsourcing platforms (e.g., a crowdsourcing platform-1 104a and a crowdsourcing platform-2 104b). One or more workers are registered with the one or more crowdsourcing platforms. Further, the crowdsourcing platform (such as the crowdsourcing platform-1 104a or the crowdsourcing platform-2 104b) may crowdsource one or more tasks by offering the one or more tasks to the one or more workers. In an embodiment, the crowdsourcing platform (e.g., 104a) presents a user interface to the one or more workers through a web-based interface or a client application. The one or more workers may access the one or more tasks through the web-based interface or the client application. Further, the one or more workers may submit a response to the crowdsourcing platform (i.e., 104a) through the user interface.

A person skilled in the art would understand that though FIG. 1 illustrates the crowdsourcing platform server 102 as hosting only two crowdsourcing platforms (i.e., the crowdsourcing platform-1 104a and the crowdsourcing platform-2 104b), the crowdsourcing platform server 102 may host more than two crowdsourcing platforms without departing from the spirit of the disclosure. Alternatively, the crowdsourcing platform server 102 may host a single crowdsourcing platform.

In an embodiment, the crowdsourcing platform server 102 may be realized through an application server such as, but not limited to, a Java application server, a .NET framework, and a Base4 application server.

The requestor-computing device 110 is a computing device used by a requestor to upload a first multimedia content and a second multimedia content to the application server 106. In addition, the requestor may also send confidentiality criteria, a criterion for segregating the first multimedia content, and images of sample objects of interest to the application server 106 through the requestor-computing device 110. In an embodiment, the application server 106 may use the confidentiality criteria to identify one or more entities that include confidential/private information in the first multimedia content. Further, in an embodiment, the application server 106 may segregate the first multimedia content in one or more multimedia snippets based on the criterion for segregation. In addition, the application server 106 may use the images of the sample objects of interest to identify one or more objects of interest in the first multimedia content. In an embodiment, the requestor-computing device 110 may include an image/video capture device. Alternatively, the requestor-computing device 110 may be communicatively coupled to the image/video capture device. In an embodiment, the image/video capture device may generate the first multimedia content by capturing live snapshots or video footages of a location of interest. In an embodiment, the image/video capture device may store the first multimedia content on the database server 112. In such a scenario, the requestor-computing device 110 may only send the second multimedia content to the application server 106, while the application server 106 may extract the first multimedia content from the database server 112. In an embodiment, an animation software may be installed on the requestor-computing device 110. The requestor may utilize the animation software to generate the second multimedia content. Examples of the requestor-computing device 110 include, but are not limited to, a personal computer, a laptop, a personal digital assistant (PDA), a mobile device, a tablet, or any other computing device.

A person having ordinary skill in the art would appreciate that the scope of the disclosure is not limited to realizing the application server 106 and the requestor-computing device 110 as separate entities. In an embodiment, the application server 106 may be realized as an application program installed on and/or running on the requestor-computing device 110 without departing from the scope of the disclosure.

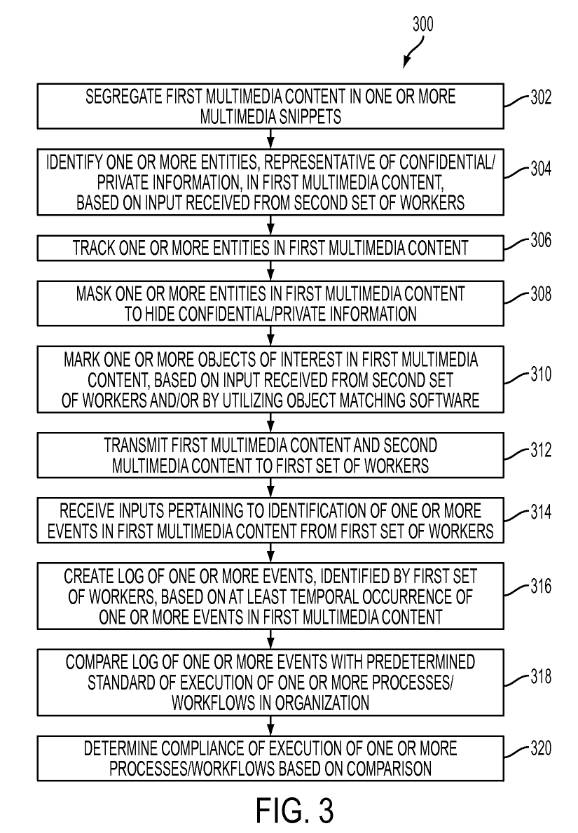

In an embodiment, the application server 106 may include programs/modules/computer executable instructions for creating a log of one or more events in a first multimedia content. In an embodiment, the application server 106 may receive the first multimedia content and the second multimedia content from the requestor-computing device 110, which the application server 106 may store on the database server 112. Alternatively, the application server 106 may receive only the second multimedia content from the requestor-computing device 110 and extract the first multimedia content from the database server 112, in case the first multimedia content is pre-stored on the database server 112. The application server 106 may send the first and the second multimedia contents to the crowdsourcing platform (e.g., 104a) for crowdsourcing to a first set of workers from the one or more workers. In an embodiment, the first set of workers may identify the one or more events in the first multimedia content by utilizing the second multimedia content. In an embodiment, the second multimedia content may include an animation illustrative of the one or more events associated with each of the one or more events. Thereafter, the application server 106 may receive the one or more identified events in the first multimedia content from the first set of worker through the crowdsourcing platform (e.g., 104a). Further, the application server 106 may create the log of the one or more events in the first multimedia content based on a temporal occurrence of the one or more events in the first multimedia content. In an embodiment, the application server 106 may store the created log on the database server 112. In addition, the application server 106 may send the log to the requestor-computing device 110. An embodiment of a method for creation of the log of the one or more events in the first multimedia content has been explained further in conjunction with FIG. 3.

Prior to sending the first multimedia content to the crowdsourcing platform (e.g., 104a) for crowdsourcing to the first set of workers, in an embodiment, the application server 106 may segregate the first multimedia content in one or more multimedia snippets. In an embodiment, the segregation of the first multimedia content may be based on a predetermined heuristic or an input from the requestor. Further, as explained above, the requestor may provide the confidentiality criteria along with the first multimedia content. The application server 106 may crowdsource the first multimedia content to a second set of workers, from the one or more workers, through the crowdsourcing platform (e.g., 104a). In addition, the application server 106 may send the confidentiality criteria to the second set of workers through the crowdsourcing platform (e.g., 104a). The second set of workers may identify the one or more entities based on the confidentiality criteria. Based on the one or more entities identified by the second set of workers, the application server 106 may track the one or more entities in the first multimedia content by utilizing an object tracking software 108a. Thereafter, the application server 106 may mask the one or more entities in the first multimedia content to hide the confidential/private information in the first multimedia content. Further, in an embodiment, the one or more objects of interest may be marked in the first multimedia content based on the images of sample objects of interest provided by the requestor. To that end, the application server 106 may mark the one or more objects of interest in the first multimedia content by utilizing an object matching software 108b based on the images of sample objects of interest. In another embodiment, the application server 106 may crowdsource the marking of the one or more objects of interest to the second set of crowdworkers through the crowdsourcing platform (e.g., 104a).

Post the marking of the one or more objects of interest in the first multimedia content, in an embodiment, the application server 106 may send the first multimedia content and the second multimedia content to the crowdsourcing platform (e.g., 104a) for crowdsourcing to the first set of workers.

In an embodiment, the application server 106 may be configured to determine a compliance of an execution of one or more processes/workflows in an organization. In such a scenario, the first multimedia content may be related to the execution of the one or more processes/workflows. For example, in case the organization is a healthcare provider such as a hospital or a clinic, the one or more processes/workflows may correspond to a treatment procedure (e.g., a surgery procedure) performed on one or more patients of the healthcare provider. The application server 106 may create the log of the one or more events in a manner similar to that described above. Thereafter, the application server 106 may compare the log with a predetermined standard for the execution of the one or more processes/workflows. In an embodiment, the predetermined standard may correspond to a set of rules related to an appropriate execution of the one or more processes/workflows. In an embodiment, the predetermined standard may be represented in one or more standard process formalisms such as, but not limited to, Petri nets, BPMN (Business Process Modelling Notation), EPCs (Event Driven Process Chains) etc. In such a scenario, the application server 106 may generate the log in a format similar to the one or more standard process formalisms, so that the log may be compared with the predetermined standard. In an embodiment, the predetermined standard may be stored on the database server 112. In such a scenario, the application server 106 may first extract the predetermined standard from the database server 112. Thereafter, based on the comparison, the application server 106 may determine the compliance of the execution of the one or more processes/workflows. An embodiment of a method for determining the compliance of the execution of the one or more processes/workflows in the organization has been explained further in conjunction with FIG. 3.

Some examples of the application server 106 may include, but are not limited to, a Java application server, a .NET framework, and a Base4 application server.

A person with ordinary skill in the art would understand that the scope of the disclosure is not limited to illustrating the application server 106 as a separate entity. In an embodiment, the functionality of the application server 106 may be implementable on/integrated with the crowdsourcing platform server 102.

In an embodiment, the database server 112 is configured to store the first and the second multimedia contents. Further, the database server 112 may also store the confidentiality criteria and the images of the sample objects of interest. In addition, the database server 112 may store the log generated by the application server 106. In an embodiment, the database server 112 may receive a query from the crowdsourcing platform server 102 and/or the application server 106 to access/extract at least the first multimedia content and the second multimedia content from the database server 110. In addition, the database server 112 may receive a query from the requestor-computing device 110 to access/extract at least the log. The database server 112 may be realized through various technologies such as, but not limited to, Microsoft® SQL Server, Oracle®, IBM DB2®, Microsoft Access®, PostgreSQL®, MySQL® and SQLite®, and the like. In an embodiment, the crowdsourcing platform server 102, the application server 106, and/or the requestor-computing device 110 may connect to the database server 112 using one or more protocols such as, but not limited to, Open Database Connectivity (ODBC) protocol and Java Database Connectivity (JDBC) protocol.

A person with ordinary skills in the art would understand that the scope of the disclosure is not limited to the database server 112 as a separate entity. In an embodiment, the functionalities of the database server 112 can be integrated into the crowdsourcing platform server 102 and/or the application server 106.

The worker-computing device 114 is a computing device used by a crowdworker. The worker-computing device 114 is configured to present the user interface (received from the crowdsourcing platform, e.g., 104a) to the worker. The worker receives the one or more tasks from the crowdsourcing platform (i.e., 104a) through the user interface. Thereafter, the worker submits the responses for the one or more tasks through the user interface to the crowdsourcing platform (i.e., 104a). In an embodiment, the worker-computing device 114 may include hardware and software for playing the first and the second multimedia content. For example, the worker-computing device 114 may include a display device and an audio device to play a video and an audio in the first and the second multimedia content. Further, the worker-computing device 114 may have a media player software such as, but not limited to, VLC Media Player, Windows Media Player, Adobe Flash Player, Apple QuickTime Player, etc., for playing the first and the second multimedia contents using the display and the audio devices of the worker-computing device 114. Examples of the worker-computing device 114 include, but are not limited to, a personal computer, a laptop, a personal digital assistant (PDA), a mobile device, a tablet, or any other computing device.

The network 116 corresponds to a medium through which content and messages flow between various devices of the system environment 100 (e.g., the crowdsourcing platform server 102, the application server 106, the requestor-computing device 110, the database server 112, and the worker-computing device 114). Examples of the network 116 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 116 in accordance with various wired and wireless communication protocols such as Transmission Control Protocol and Internet Protocol (TCP/IP), User Datagram Protocol (UDP), and 2G, 3G, or 4G communication protocols.

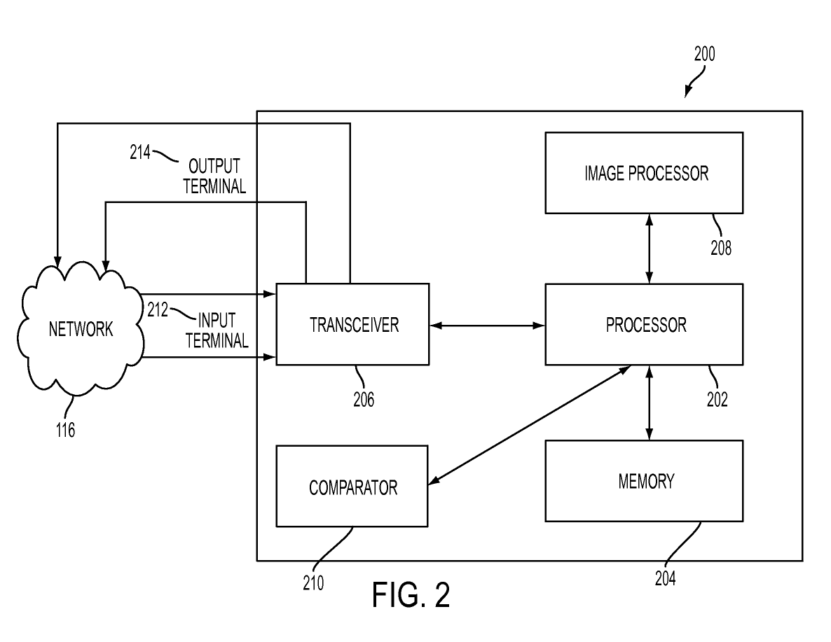

FIG. 2 is a block diagram that illustrates a system 200 configured for creating the log of the one or more events, in accordance with at least one embodiment. In an embodiment, the system 200 may correspond to the crowdsourcing platform server 102, the application server 106, or the requestor-computing device 110. For the purpose of ongoing description, the system 200 is considered as the application server 106. However, the scope of the disclosure should not be limited to the system 200 as the application server 106. In an embodiment, the system 200 can also be realized as the crowdsourcing platform server 102 or the requestor-computing device 110 without departing from the spirit of the disclosure.

The system 200 includes a processor 202, a memory 204, a transceiver 206, an image processor 208, and a comparator 210. The processor 202 is coupled to the memory 204, the transceiver 206, the image processor 208, and the comparator 210. The transceiver 206 is connected to the network 116 through an input terminal 212 and an output terminal 214.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the system 200 to perform the predetermined operations.

The transceiver 206 transmits and receives messages and data to/from various components of the system environment 100 (e.g., the crowdsourcing platform server 102, the requestor-computing device 110, the database server 112, and the worker-computing device 114) over the network 116. In an embodiment, the transceiver 206 is coupled to the input terminal 212 and the output terminal 214 through which the transceiver 206 may receive and transmit data/messages, respectively. Examples of the transceiver 206 may include, but are not limited to, an antenna, an Ethernet port, a USB port, or any other port that can be configured to receive and transmit data. The transceiver 206 transmits and receives data/messages in accordance with the various communication protocols such as, TCP/IP, UDP, and 2G, 3G, or 4G communication protocols.

The image processor 208 is a processor configured to perform one or more image processing/analysis operations on an image/video/multimedia content. In an embodiment, the image processor 208 may include one or more electronic circuits and/or gates configured to perform one or more predefined digital signal processing operations. Examples of the one or more predefined digital signal processing operations include, but are not limited to, a signal transformation (e.g., conversion of a signal from time to frequency domain and vice versa), a noise reduction, a signal filtration, a signal thresholding, a signal attenuation, and so on. In an embodiment, the image processor 208 may utilize the object tracking software 108a and/or the object matching software 108b to process/analyze the image/video/multimedia content. Though the image processor 208 is depicted as separate from the processor 202, a person skilled in the art would appreciate that the scope of the disclosure is not limited to realizing the image processor 208 as a separate entity. In an embodiment, the image processor 208 may be implemented within the processor 202 without departing from the spirit of the disclosure.

The comparator 210 is configured to compare at least two input signals to generate an output signal. In an embodiment, the output signal may correspond to either ‘1’ or ‘0’. In an embodiment, the comparator 210 may generate output ‘1’ if the value of a first signal (from the at least two signals) is greater than a value of the second signal (from the at least two signals). Similarly, the comparator 210 may generate an output ‘0’ if the value of the first signal is less than the value of the second signal. In an embodiment, the comparator 210 may be realized through either software technologies or hardware technologies known in the art. Though, the comparator 210 is depicted as independent from the processor 202 in FIG. 2, a person skilled in the art would appreciate the comparator 210 may be implemented within the processor 202 without departing from the scope of the disclosure.

A person skilled in the art would appreciate that the scope of the disclosure is not limited to the comparator 210, as described above. In an embodiment, the comparator 210 may be capable of performing complex comparison operations such as comparing the log of the one or more events with the predetermined standard to identify deviations from the predetermined standard. Examples of such deviations may include, but are not limited to, a missing event in the log with respect to an activity, an unexpected sequencing of the events in the log, an event occurring at an unexpected time (either earlier or later than that specified in the predetermined standard), a frequency of deviations related to an activity, a stage in the process/workflow affected by the deviations, and so on.

In operation, in an embodiment, the processor 202 may be configured to create the log of the one or more events identified from the first multimedia content. In an embodiment, the processor 202 may receive the first and the second multimedia contents from the requestor-computing device 110 through the transceiver 206. Thereafter, the processor 202 may utilize the image processor 208 to segregate the first multimedia content in the one or more multimedia snippets based on the criterion for segregation received from the requestor. Further, the processor 202 may identify the one or more entities, representative of the confidential/private information in the first multimedia content, by crowdsourcing the first multimedia content to the second set of workers and/or by utilizing the image processor 208. In an embodiment, the processor 202 may further send the confidentiality criteria along with the first multimedia content to the second set of workers. The second set of workers may identify the one or more confidential information/entities in the first multimedia content according to the confidentiality criteria. The image processor 208 may then track the one or more identified entities in the first multimedia content by utilizing the object tracking software 108a. Further, the image processor 208 may mask the one or more identified entities in the first multimedia content. Thereafter, in an embodiment, the image processor 208 may mark the one or more objects of interest in the first multimedia content by utilizing the object matching software 108b, based on the images of the sample objects of interest provided by the requestor. Alternatively, the processor 202 may send the first multimedia content the crowdsourcing platform (e.g., 104a), via the transceiver, for crowdsourcing to the second set of workers along with the information about the object of interests received from the requestor. In such a scenario, the one or more objects of interest may be marked by/verified by the second set of workers. Once the one or more objects of interest are marked in the first multimedia content, in an embodiment, the processor 202 may send the first and the second multimedia content to the crowdsourcing platform (e.g., 104a), via the transceiver 206, for crowdsourcing to the first set of workers.

In a scenario, where the first multimedia content is segregated in one or more multimedia snippets, in an embodiment, each multimedia snippet of the first multimedia content may be crowdsourced as a separate crowdsourcing task along with the second multimedia content to each worker from the first set of workers. The first set of workers may provide responses to the crowdsourcing task (that includes the multimedia snippet) by identifying the one or more events in the multimedia snippet by utilizing the second multimedia content. Thereafter, the processor 202 may collate the response received for the various multimedia snippets of the first multimedia content. Further, the processor 202 may create the log of the one or more identified events based on the temporal occurrence of the one or more events in the first multimedia content. The operation of the system 200 for creating the log of the one or more events in the first multimedia content has been described further in conjunction with FIG. 3.

The processor 202 may be further configured to check the compliance of processing of the activity being performed in the first multimedia content. In such a scenario, the processor 202 may create the log of the one or more events in a manner similar to that described above. Thereafter, the processor 202 may utilize the comparator 210 to compare the log with a predetermined standard. Based on the comparison, the processor 202 may determine the compliance of the execution of the one or more processes/workflows. The operation of the system 200 for determining the compliance of the execution of the one or more processes/workflows in the organization has been described further in conjunction with FIG. 3.

FIG. 3 is a flowchart 300 illustrating a method for creating the log of the one or more events in the first multimedia content, in accordance with at least one embodiment. The flowchart 300 is described in conjunction with FIG. 1 and FIG. 2.

At step 302, the first multimedia content is segregated in the one or more multimedia snippets. In an embodiment, the image processor 208 is configured to segregate the first multimedia content. In an embodiment, the segregation may be based on a predetermined heuristic. Examples of the predetermined heuristic may include, but are not limited to, a file size requirement (e.g., splitting into 5 MB snippets), a video length requirement (e.g., splitting into snippets having at most 5.00 minutes of video content), a clipping/trimming requirement (e.g., removing video content of 2 seconds from starting and ending of each snippet), an overlap requirement (e.g., repeating 5 seconds of video content between each pair of successive snippets), a presence/absence of one or more objects of interests (e.g., video frames having a particular object of interest may be clubbed in one single snippet), and so on. In an embodiment, the segregation may be based on an input received from the requestor. For example, as discussed above, the requestor may provide a criterion for segregating the first multimedia content in the one or more multimedia snippets. In another scenario, the requestor may himself/herself perform the segregation of the first multimedia content to generate the one or more multimedia snippets by utilizing the requestor-computing device 110. For example, a video editing software may be installed the requestor-computing device 110. The requestor may use the video editing software to segregate the first multimedia content into the one or more multimedia snippets.

A person skilled in the art would appreciate that the segregation of the first multimedia content in the one or more multimedia snippets is not limited to that described above. The first multimedia content may be segregated in various ways without departing from the scope of the disclosure.

Further, a person having ordinary skill in the art would understand that the scope of the disclosure is not limited to segregating the first multimedia content as a necessary step. Further, in an embodiment, the segregation of the first multimedia content may not be performed (i.e., the processor 202 may skip the step 302 and directly perform the step 304) without departing from the spirit of the disclosure.

At step 304, the one or more entities representative of the confidential/private information in the first multimedia content may be identified. In an embodiment, the processor 202 is configured to identify the one or more entities. To that end, in an embodiment, the processor 202 may send the first multimedia content to the crowdsourcing platform (e.g., 104a) for crowdsourcing to the second set of workers. Thus, the first multimedia content may be presented to a worker from the second set of workers as a crowdsourcing task. The processor 202 may also send the confidentiality criteria (which may be provided by the requestor) to the second set of workers through the crowdsourcing platform (e.g., 104a). In an embodiment, the second set of workers may correspond to one or more workers of an organization of the requestor. In such a scenario, the processor 202 may send the first multimedia content and the confidentiality criteria to the worker-computing device 114 of respective workers as the crowdsourcing task. In an embodiment, the processor 202 may not send the confidentiality criteria to the second set of workers, if such workers are aware of the confidentiality criteria.

For example, the first multimedia content includes a video footage of a surgery performed by doctors A, B, and C on a patient X with the help of an instrument/medical equipment of company M. Further, the video footage may include a watermark specifying the name of a hospital H in which the surgery was performed. In the aforementioned example, the confidentiality criteria may state that confidential/private information includes information pertaining to the identity of the doctors (i.e., A, B, and C), the identity of the patient (i.e., X), the name/trademark of the company whose instrument/medical equipment is used (i.e., M), and the name of the hospital (i.e., H). Thus, based on the confidentiality criteria, the second set of workers may identify regions including facial features of the doctors and the patient, regions including logos on the instrument/medical equipment, and the watermark including the name of the hospital as the one or more entities.

In a scenario, where the first multimedia content is segregated into the one or more multimedia snippets, the processor 202 may send the one or more multimedia snippets to the second set of workers as the crowdsourcing tasks. In an embodiment, the second set of workers may mark the one or more entities in the respective multimedia snippets based on the confidentiality criteria (i.e., sent along with the one or more multimedia snippets).

The second set of workers may send the information pertaining to the one or more entities (that may reveal the confidential information) to the processor 202 as a response to the crowdsourcing task sent by the processor 202. In an embodiment, the second set of workers may utilize one or more input device associated with the respective worker-computing device 114, to mark the one or more entities in the multimedia snippets of the first multimedia content. A person having ordinary skill in the art would understand that the scope of the disclosure is not limited to the way the second set of workers provide the information about the one or more entities.

At step 306, the one or more entities are tracked in the first multimedia content. In an embodiment, the image processor 208 is configured to track the one or more entities in the first multimedia content by utilizing the object tracking software 108b. In an embodiment, to track the one or more entities, the object tracking software 108b may utilize one or more image processing techniques such as, but not limited to, an optical flow technique, or a contour tracking technique. A person skilled in the art would appreciate that the second set of workers may have identified the one or more entities in at least one frame of the first multimedia content. Based on the identification, the image processor 208 may track the one or more identified entities in the rest of the frames in the first multimedia content. For example, the second set of workers may have identified the one or more entities in the first frame in each of the one or more multimedia snippets. The one or more entities may be tracked in the remaining frames of each snippet using the object tracking software 108b.

A person skilled in the art would appreciate that the scope of the disclosure is not limited to the tracking the one or more entities in the first multimedia content, as discussed above. The one or more entities may be tracked by utilizing any image processing technique known in the art without departing from the spirit of the disclosure.

At step 308, the one or more entities are masked in the first multimedia content. In an embodiment, the image processor 208 is configured to mask the one or more entities in the first multimedia content to hide the confidential/private information in the first multimedia content. To mask the one or more entities, in an embodiment, the image processor 208 may fill regions containing the one or more entities with random pixel values (or white/black pixel vales) in the relevant frames of the first multimedia content. Considering the example of the video footage of the surgery, the image processor 208 may blacken the facial regions of the doctors A, B, C, and the patient X. Further, the image processor 208 may fill random pixel values in the region comprising the logos of the instrument/medical equipment and the region comprising the watermark with the name of the hospital.

A person skilled in the art would appreciate that the masking of the one or more entities in the first multimedia content is not limited to that described above. One or more image processing techniques known in the art may be utilized for masking the one or more entities without departing from the scope of the disclosure.

In a scenario, where the first multimedia content is segregated in the one or more multimedia snippets, the entities in each of the one or more multimedia snippets are masked by utilizing the techniques described in step 308.

At step 310, the one or more objects of interest are marked in the first multimedia content. In an embodiment, the image processor 208 is configured to mark the one or more objects of interest in the first multimedia content. In an embodiment, the processor 202 may receive the images of the sample objects of interest from the requestor-computing device 110. In an embodiment, the image processor 208 may utilize the object matching software 108b to mark the one or more objects of interest in the first multimedia content based on the received images of the sample objects of interest. In an embodiment, the object matching software 108b may utilize one or more image processing techniques that are translation, rotation, and scale invariant (e.g., Scale Invariant Feature Transform) to identify one or more frames in the first multimedia content that include the one or more objects of interest. However, a person skilled in the art would understand that any image processing technique known in the art may be used to identify the one or more frames. Thereafter, the one or more objects of interest may be marked in the one or more identified frames.

In a scenario where the second set of workers corresponds to one or more workers of the organization of the requestor, the processor 202 may send the respective multimedia snippets directly to the worker-computing device 114 of each such worker. In an embodiment, in addition, the processor 202 may send the images of the sample objects of interest to the second set of workers. The second set of workers may provide responses to the crowdsourcing task by marking the one or more objects of interest in the multimedia snippet associated with the crowdsourcing task, based on the images of the sample objects of interest. For example, the first multimedia content relates to a surgery being performed by three doctors A, B, and C on a patient X, using a surgical instrument M. The second set of workers may mark regions in one or more representative frames of each multimedia snippet, which are associated with the doctors A, B, and C, the patient X, and the surgical instrument M, to denote the one or more objects of interest.

A person skilled in the art would appreciate that the one or more objects of interest may be marked by utilizing the object matching software 108b, through crowdsourcing of the one or more multimedia snippets to the second set of workers, or a combination of both. When a combination of both the techniques are used for marking the one or more objects of interest, in an embodiment, the objects of interest marked by the object matching software 108b may be validated based on the marking of the one or more objects of interest by the second set of workers. Alternatively, the objects of interests marked by the second set of workers may be validated by utilizing the object matching software 108b.

Further, a person skilled in the art would appreciate that the segregation of the first multimedia content (i.e., step 302) may be performed after the marking of the one or more objects of interest in the first multimedia content. In such a scenario, the segregation may be based on the presence/absence of a given set of objects of interest in subsequent frames of the multimedia content. For example, the doctor A, the patient X, and the instrument/medical equipment M may be present in 3000 consecutive frames of the video footage of the surgery captured in the first multimedia content. The image processor 208 may segregate the first multimedia content such that these 3000 frames are clubbed into a single multimedia snippet. If a frame rate of a video footage in the multimedia content is 30 frames/sec, total length of the multimedia snippet, so segregated, may be at least 100 seconds. In a similar manner, the image processor 208 may segregate the first multimedia content into the remaining multimedia snippets.

A person skilled in the art would also appreciate that the segregation of the first multimedia content may be updated based on the marking of the one or more objects of interest in the first multimedia content. For example, the processor 202 may determine that video footage associated with one or more objects of interest (e.g., a doctor, a patient, and a surgical instrument) spans more than one multimedia snippets. Thus, it may be the case that such multimedia snippets are related to a common event/activity. Therefore, the processor 202 may combine one or more of such multimedia snippets into a single multimedia snippet. Similarly, if a multimedia snippet includes objects of interest of various types, which may not be involved in a single/common event/activity, the processor 202 may segregate such multimedia snippets further. A person skilled in the art would also appreciate that the segregation of the first multimedia content may be supplemented based on inputs from the first/second sets of workers. For instance, the workers in the first/second sets of workers may identify whether the current segregation of the first multimedia content is in accordance to the occurrence of the various activities within the first multimedia content. Thus, if an activity spans between two or more multimedia snippets, workers may provide inputs indicative of such instances. Based on such inputs, the processor 202 may combine the relevant multimedia snippets.

At step 312, the first multimedia content and the second multimedia content are transmitted to the first set of workers. In an embodiment, the processor 202 is configured to transmit each multimedia snippet of the first multimedia content and the second multimedia content to the first set of workers as a crowdsourcing task through the crowdsourcing platform (e.g., 104a). When the first set of workers correspond to one or more workers of the organization of the requestor, the processor 202 may directly send the crowdsourcing task (including the respective multimedia snippet and the second multimedia content) to the worker-computing device 114 of each such worker. A person skilled in the art would appreciate that the first set of workers may be different from the second set of workers for confidentiality purposes. Once the crowdsourcing task is presented on the worker-computing device 114, the multimedia snippet (of the first multimedia content) associated with the crowdsourcing task and the second multimedia content may be played on the worker-computing device 114 using a media player software installed on the worker-computing device 114. In an embodiment, the first set of workers may utilize the second multimedia content to identify the one or more events in the multimedia snippet associated with the crowdsourcing task. The second multimedia content may include an animation illustrative of the one or more events. Further, the second multimedia content may include a short description of the various activities involved each event. A person skilled in the art would appreciate that the one or more events may relate to one or more activities involving/associated with the one or more objects of interests. For example, the first multimedia content includes a video footage of an activity such as a surgery performed by a team of doctors on a patient. The second multimedia content may include an animation illustrating a sequence of activities that may be performed by the doctors during the surgery using one or more surgical instruments. For instance, the second multimedia content may illustrate that the doctors may perform activities A, B, C, and D, in that order. The first set of workers may view the second multimedia content and ascertain which portions of the video footage in the multimedia snippet correspond to which activity. Thereafter, the first set of workers may identify the one or more events in the multimedia snippet as a beginning, an end, or an intermediate step in respective activities. For example, the first set of workers may identify a start of an activity-1 as an event-1. Further, the first set of workers may identify an event-2 and an event-3 as two intermediate steps in the activity-1 and an event-4 as the completion of the activity-1, and so on. The first set of workers may also provide timestamps of the occurrence of the identified events in the multimedia snippets of the first multimedia content as an offset from the start of the multimedia snippet. For instance, a worker identifies an event occurring in a snapshot in the multimedia snippet at 3:05 minutes from the start of the multimedia snippet. Hence, the timestamp of the occurrence of this event is 3:05 minutes.

A person skilled in the art would appreciate that the crowdsourcing of the first multimedia content to the first set of workers may include crowdsourcing of the individual multimedia snippets in the first multimedia content to one or more workers from the first set of workers. Each of the one or more multimedia snippets may be used to create one or more crowdsourcing tasks. Each crowdsourcing task may include at least one multimedia snippet.

At step 314, responses to the crowdsourcing task are received from the first set of workers. In an embodiment, the processor 202 is configured to receive the responses to the crowdsourcing task from the first set of workers through the crowdsourcing platform (e.g., 104a). Each response may include one or more inputs pertaining to the identification of the one or more events in the respective multimedia snippet associated with the crowdsourcing task. In an embodiment, the each worker from the first set of workers may provide the one or more inputs through the user-interface of the respective worker-computing device 114. The first set of workers may be initially incognizant of the one or more events. As explained earlier, on receiving the crowdsourcing task, the first set of workers may play the second multimedia content using a media player software installed on the respective worker-computing devices 114. Thereafter, the first set of workers may play the multimedia snippet in the crowdsourcing task using the media player software and identify the one or more events based on the second multimedia content.

For example, the first multimedia content is related to a surgery performed by a team of doctors on a patient using one or more medical/surgical instruments. The second multimedia content may include an animation of one or more activities that may be involved in performing the surgery. For instance, the one or more activities may include sanitizing the surgical instruments, injecting the patient with a dose of anesthetic medicine, cleaning a part of the patient's body on which the surgery is to be performed, one or more surgery specific steps (e.g., removing of a blood clot), stitching the wound formed due to the surgery, and one or more post-operative steps. Further, each activity may involve an interaction or association of the one or more objects of interest. For instance, an activity may include one or more steps performed by one or more resources. In the above example, the one or more resources may include the one or more doctors in the team of doctors. The one or more steps involved in the activity of sanitization of the surgical instruments may include the doctors sterilizing the surgical instruments using a spirit or an antiseptic solution, and thereafter cleaning the surgical instruments with one or more pieces of fresh cotton wool, and so on. As explained, the first set of workers may be incognizant of the one or more events. (e.g., a worker may not know how a particular surgery is performed). Each worker from first set of workers may view the second multimedia content and identify the one or more events in the multimedia snippet of the respective crowdsourcing task received worker. A worker may identify a first event as a start of an activity, a second event as an intermediate step of the activity, and a third event as an end of that activity. For instance, a worker may identify an event-1 as the start of the activity of sanitization of the surgical instruments, an event-2 as an intermediate step in this activity, which the doctors did not perform properly (e.g., cleaning using the cotton wool, etc.), an event-3 as the end of this activity, and so on.

In an embodiment, the responses provided by the first set of workers may include inputs such as, but not limited to, an identification of the one or more events in the multimedia snippet associated with the respective crowdsourcing task, a timestamp of each event as an offset from the start of the multimedia snippet, an identification of type of each event, and a tag associated with each event. As explained earlier, an event may be representative of a start, an intermediate step, or an end of an activity in the one or more multimedia snippets of the first multimedia content. The type of the event may indicate whether the event marks a start, an intermediate step, or an end, of an activity. Hence, an event may be of either a type “start”, “intermediate step”, or “complete”. Further, the first set of workers may provide a timestamp associated with each identified event as an offset from the start of the multimedia snippet. The first set of workers may provide additional information pertaining to the event as the tag associated with the event. The tag may include a text describing the event or certain objects of interest involved in the activity/intermediate step of the activity. For example, if an event-1 relates to measuring a physiological parameter of a patient, the tag may include values of the measured physiological parameter, in addition to the type of the physiological parameter being measured (e.g., heart rate, blood pressure, etc.) and the instrument/machine (e.g., stethoscope, sphygmomanometer, etc.) being used to measure the value of the physiological parameter, and so on. Further, in an embodiment, the first set of workers may also identify the one or more resources (e.g., doctors, nurses, etc.) who performed the activity (which in this case is the measurement of physiological parameters of the patient). The identification of the one or more resources may also be provided by the first set of workers within the tag of the event.

Further, the responses received from the first set of workers may also include inputs identifying any oral utterances in the respective multimedia snippet of the crowdsourcing task. For instance, the multimedia snippet may include a video footage of a doctor asking a nurse “What is the B.P. (Blood Pressure) of the patient?” the nurse measuring the B.P., and responding to the question as “120/80”. In such a scenario, the first set of workers may record the question asked by the doctor and the response provided by nurse as tags related to the event of measuring the B.P. of the patient.

In an embodiment, the processor 202 may validate the inputs received from the first set of workers. For example, the processor 202 may crowdsource the same multimedia snippet to multiple workers in the first set of workers. Thereafter, the processor 202 may utilize the comparator 210 to compare the responses received from the multiple workers for the multimedia snippet. Based on the comparison, the processor 202 may validate the responses and determine a consolidated response, which may be used to create the log. In an embodiment, the processor 202 may perform a majority/consensus based validation of the responses received from the workers. For instance, a multimedia snippet M-1 is crowdsourced to three workers. If at least two of the workers provide the same response, the two matching responses are determined as correct and are considered as the consolidated response for the multimedia snippet M-1. Further, in a scenario where a consensus is not reached, the processor 202 may crowdsource the multimedia snippet to a set of workers in the first set of workers, who did not work on the multimedia snippet. For example, a worker W1 provides a response indicating that the timestamp of an event-1 is t1. Further, workers W2 and W3 provide responses indicating that the timestamp of the event-1 is t2 and t3, respectively. Thus, consensus on the responses is not reached. The processor 202 may crowdsource the multimedia snippet to one or more other workers. Further, the processor 202 may transmit a question such as “Does the event-1 occur at timestamp t1, t2, or t3 (or any other value)?” The processor 202 may validate responses received from the one or more other workers and determine a consolidate response for the multimedia snippet, which may then be used to create the log.

At step 316, the log of the one or more events is created. In an embodiment, the processor 202 is configured to create the log of the one or more events identified by the first set of workers based on at least a temporal occurrence of the one or more events in the first multimedia content. In an embodiment, the processor 202 may store the created log in the database server 112. Alternatively (or additionally), the processor 202 may transmit the created log to the requestor-computing device 110. The log may be stored in various formats such as, but not limited to, DBMS tables (e.g., Access, Oracle, etc.), spreadsheets, or XML format (e.g., MXML and XES (eXtensible Event Streams). In an embodiment, the log of the one or more events may comprise one or more attributes related to the one or more events. Examples of the one or more attributes related to the one or more events include, but are not limited to, a timestamp associated with the event, a tag associated with the event, a type of the event, one or more objects of interest involved in an activity associated with the event, an identification (ID) of the event (for referencing and retrieving the details of the event from the log). The following table illustrates an example of the log of the one or more events related to a scenario where the first multimedia content captures execution of one or more processes/workflows in a print shop:

TABLE 1
An example of the log of the one or more events related to
execution of one or more processes/workflows in a print shop

| Event ID | Activity | Timestamp | Event type | Resources | Tag |
|---|---|---|---|---|---|
| Event-1 | Procurement | 12-15-2014; | start | M, S | — |
| | | 10:15 hours | | | |
| Event-2 | Procurement | 12-15-2014; | inter- | M, S | Quality |
| | | 11:05 hours | mediate | | Check |
| | | | step | | of |
| | | | | | sheets |
| | | | | | missed |
| Event-3 | Procurement | 12-15-2014; | complete | M, S | — |
| | | 11:35 hours | | | |
| Event-4 | Order | 12-15-2014; | start/ | K | — |
| | Receipt | 11:55 hours | complete | | |
| Event-5 | Order Set-up | 12-15-2014; | start | J | — |
| | | 12:25 hours | | | |
| Event-6 | Order Set-up | 12-15-2014; | complete | J | — |
| | | 12:35 hours | | | |
| Event-7 | Printing | 12-15-2014; | start | A | — |
| | | 12:40 hours | | | |
| Event-8 | Printing | 12-15-2014; | complete | A | — |
| | | 13:20 hours | | | |
| Event-9 | Dispatch | 12-15-2014; | start | M | — |
| | | 13:35 hours | | | |
| Event-10 | Dispatch | 12-15-2014; | complete | M | — |
| | | 13:40 hours | | | |
| Event-11 | Invoicing | 12-15-2014; | start/ | K | — |
| | | 13:45 hours | complete | | |

As shown in the above table, the log includes information pertaining to the one or more events such as an event ID, an activity captured by the event, a timestamp associated with the event, a type of the event, and a resource (or object of interest) involved in the activity indicated by the event. Each row of the above table illustrates information pertaining to a particular event in the log. For instance, the first row records an event-1, which indicates a start of an activity “Procurement”, performed by the resources “M” and “S”. The event-1 has a timestamp of 12-15-2014 (date), 10:15 hours (time). Thus, the activity “Procurement” starts at 10:15 hours on 12-15-2014. Further, the second row of the above table records an event-2, which relates to an intermediate step of the activity “Procurement” at 11:05 hours on 12-15-2014. The resources involved in the event-2 are also “M” and “S”. The tag of event-2 is “Quality Check of sheets missed”. Thus, the resources “M” and “S” may not have checked a sample of sheets (raw material) for quality at this intermediate step. Row 3 of Table 1 records an event-3 that indicates the completion of the “Procurement” activity by “M” and “S” at 11:35 hours on 12-15-2014. The remaining rows of table 1 depict information pertaining to events related to the rest of the activities involved in the execution of the processes/workflows followed in the print shop such as Order Receipt (event-4), Order Set-up (event-5 and event-6), Printing (event-7 and event-8), Dispatch (event-9 and event-10), and Invoicing (event-11).

A person skilled in the art would appreciate that the above example of the log of the one or more events (as illustrated in Table 1) is for illustrative purposes and should not be construed to limit the scope of the disclosure. The log of the one or more events may be generated for recording execution of workflows/processes related to an organization of any industry without departing from the spirit of the disclosure. Further, the scope of the disclosure should not be limited to the types of events and examples of activities, as discussed above.

Further, as discussed, the private/confidential information within the first multimedia content is hidden (step 308), and the one or more entities include the objects of interest, one or more regions in the first multimedia content that reveal the identity or other sensitive information of the objects of interest may be hidden. Thus, the hiding of the identity/other sensitive information of the objects of interest may include a substitution of the information revealing the actual identity with a dummy value. For example, a facial region of one or more doctors and a patient may be hidden in the first multimedia content capturing a surgery procedure. The facial regions of the doctors may be tagged with a first set of dummy values, for example, resource R1, resource R2, resource R3, etc., while the facial regions of the patient may be tagged with a second dummy value, for example, consumer C1. In an embodiment, while identifying the one or more events, the first set of workers may provide inputs pertaining to such objects of interest in terms of the respective dummy values tagged/associated with the objects of interest. The processor 202 may map the respective dummy values back to the information related to the identity of the objects of interest based on a look-up table. In an embodiment, the database server 112 may store the look-up table that includes the mapping of the respective dummy values and the information related to the identity of the objects of interest.

A person skilled in the art would appreciate the examples of the log of the one or more events and the one or more attributes of the one or more events have been provided for illustrative purposes only and should not be construed to limit the scope of the disclosure. Further, the scope of the disclosure should not be limited to the creation of the log, as disclosed above. The log of the one or more events may be created using various techniques without departing from the spirit of the disclosure.

By analyzing the various entries in the log, the requestor may identify one or more flaws in execution of the one or more activities captured by the events. For example, if a first activity takes a longer than expected time or involves more resources (or objects of interest) than expected, the activity may be identified as a bottleneck. The requestor may then focus his/her attention on analysis of activities of that particular type. Alternatively, the requestor may analyze activities involving the resources (or objects of interests) that were involved/associated with the first activity.

At step 318, the log of the one or more events is compared with a predetermined standard. In an embodiment, the processor 202 is configured to compare the log of the one or more events with the predetermined standard by utilizing the comparator 210. Prior to the comparison, the processor 202 may extract the predetermined standard from the database server 112, if the predetermined standard is pre-stored on the database server 112. Alternatively, the processor 202 may receive the predetermined standard from the requestor-computing device 110. In an embodiment, the predetermined standard may correspond to a set of rules related to an appropriate execution of the one or more processes/workflows. Further, in an embodiment, the predetermined standard may be represented in one or more standard process formalisms such as, but not limited to, Petri nets, BPMN (Business Process Modelling Notation), EPCs (Event Driven Process Chains) etc. In such a scenario, the processor 202 may generate the log in a format similar to the one or more standard process formalisms, so that the log may be compared with the predetermined standard. The following table illustrates an example of a predetermined standard of execution of processes/workflows in a print shop:

TABLE 2
An example of the predetermined standard for execution of
processes/workflows in a print shop

| | Standard Completion | |
|---|---|---|
| Activity | Time (hours) | No. of Resources |
| Procurement | 01:00 | 3 |
| Order Receipt | — | 1 |
| Order Set-up | 00:15 | 1 |
| Printing | 00:15 | 1 |
| Dispatch | 00:05 | 1 |
| Invoicing | — | 1 |

As illustrated in the above table, the predetermined standard defines a standard completion time (in hours or minutes) for execution of the various processes/workflows in the print shop such as Procurement, Order Receipt, Order Set-up, Printing, Dispatch, and Invoicing. Further, the predetermined standard also defines a number of resources that may be employed in each activity. For instance, the activity Procurement may be performed by up to 3 resources in a standard completion time of 1:00 hour. Considering the log of the or more events illustrated in Table 1, the processor 202 may determine a time taken to complete the activity Procurement as a difference of the timestamps of the event-1 (starting time of the activity Procurement) from the event-3 (completion time of the activity Procurement). Thereafter, the processor 202 may utilize the comparator 210 to compare the difference of the timestamps of the event-1 and the event-3 with the standard completion time of the activity Procurement (i.e., 1 hour). Clearly, the difference between the timestamps (i.e., 1 hour 20 minutes) is greater than the standard completion time (1 hour). Similarly, the processor 202 determines that the number of resources involved in the event-1 and the event-3 as 2 (i.e., “M” and “5”), and hence are within the standard number of resources defined by the predefined standard (i.e., 3). Similarly, the rest of the events in the log may be compared with the predefined standard. Based on the comparison, a compliance of the execution of the various processes/workflows with the predetermined standard may be determined, as explained next.

A person skilled in the art would appreciate that the examples of the predetermined standard are for illustrative purposes only and should not be construed to limit the scope of the disclosure. In an embodiment, the predetermined standard may be an industry-specific standard defined by a standard defining body such as, but not limited to, a regulatory body, a statutory body, a consortium of organizations in an industry, a government body, or a non-profit organization.

At step 320, a compliance of the execution of the various processes/workflows with the predetermined standard is determined. The processor 202 is configured to determine a compliance of the execution of the various processes/workflows with the predetermined standard based on the comparison performed at step 318. Considering an example scenario in which the log of the one or more events is as illustrated in Table 1 and the predetermined standard is as illustrated in Table 2. As explained in step 318, the processor 202 (by utilizing the comparator 210) may compare the log of the one or more events with the predetermined standard. For instance, the event-1 and the event-3 relate to the start and the completion of the activity Procurement, respectively. The processor 202 may subtract the timestamps of the event-1 and event-3 and compare the difference with the standard completion time of the activity Procurement. As the difference between the timestamps is determined as 1:20 hours and the standard completion time is 1:00 hour, the processor 202 may determine that the execution of the activity Procurement may not comply with the predetermined standard. The processor 202 may also compare the other attributes of the event-1, the event-2, and the event-3 with the respective values defined in the predetermined standard. For instance, the processor 202 may determine that the 2 resources are employed in the activity Procurement, while the standard number of resources may be 3. Based on such comparisons, the processor 202 may determine whether the activity Procurement is in accord with the predetermined standard. Similarly, the processor 202 may determine the compliance of the execution of the various processes/workflows with the predetermined standard with respect to the other activities.

Further, in an embodiment, the processor 202 may also compare the sequence of the one or more events in the log with the predetermined standard. For example, the predetermined standard may include an ideal sequence of the one or more events. Based on the comparison, if the processor 202 determines that the sequence of the one or more events in the log is different from the ideal sequence of the one or more events in the predetermined standard, the processor 202 may determine that the processing of the execution of the one or more processes/workflows is not in accordance with the predetermined standard. Thus, in an embodiment, the processor 202 (by utilizing the comparator 210) may compare the log with the predetermined standard, as specified in the one or more standard process formalisms (such as, but not limited to, Petri nets, BPMN, EPCs, etc.) to identify deviations of the activities from the predetermined standard. Examples of such deviations may include, but are not limited to, a missing event in the log with respect to an activity, an unexpected sequencing of the events in the log, an event occurring at an unexpected time (either earlier or later than that specified in the predetermined standard), a frequency of deviations related to an activity, a stage in the process/workflow affected by the deviations, and so on.

In an embodiment, the requestor may provide one or more tolerance values associated with each standard value. For instance, the requestor may provide a tolerance value of ±10% for the standard completion time of the activity Procurement. Hence, if the time taken for the activity Procurement (as per the events in the log) is within ±10% of 1 hour, the execution of the one or more processes/workflows may be determined as complying with respect to the activity Procurement. Further, the requestor may specify a relative importance of each activity in the execution of the one or more processes/workflows by assigning a weight to each activity. In addition, the requestor may also specify a weight for each attribute of the one or more events. In an embodiment, the processor 202 may assign a score to each activity within the log based on the comparison with the predetermined standard. For instance, the processor 202 may determine a ratio (R1) of the time taken for completion of an activity A in the log and the standard completion time of that activity A. Similarly, the processor 202 may determine a ratio (R2) for the number of resources. Thereafter, the processor 202 may determine the score (S) for the activity A as a weighted sum of the ratios R1 and R2 (based on the relevant weights specified by the requestor). Further, the processor 202 may determine a weighted score (WS) for the execution of the one or more processes/workflows based on the scores of the individual activities and the weights assigned to the individual activities by the requestor. The compliance of the execution of the one or more processes/workflows as a whole may be determined based on a comparison of the weighted score (WS) with a predetermined threshold. In an embodiment, the requestor may provide the predetermined threshold.

A person skilled in the art would appreciate that the scope of the disclosure should not be limited to the requestor providing the one or more tolerance values for each standard value. In an embodiment, the requestor may specify a statistical distribution for each standard value. For instance, the requestor may specify that the Standard Completion Time for the activity Procurement follows a normal distribution with a mean of 1 hour and a standard deviation of 12 minutes. Similarly, the requestor may specify that the standard value of the Number of Resources for the activity Procurement may follow a binomial distribution, and so on.

A person skilled in the art would appreciate that the scope of the disclosure should not be limited to the determination of the compliance of the execution of the processes/workflows as disclosed above. The compliance of the execution of the processes/workflows may be checked using various other techniques.

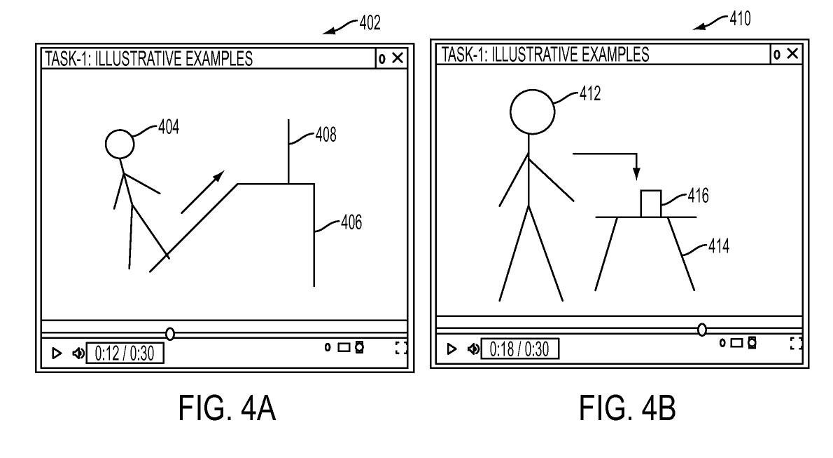

FIGS. 4A and 4B illustrate example user-interfaces (402 and 410, respectively) that may be presented on the worker-computing device 114 to display the second multimedia content to the worker, in accordance with at least one embodiment.

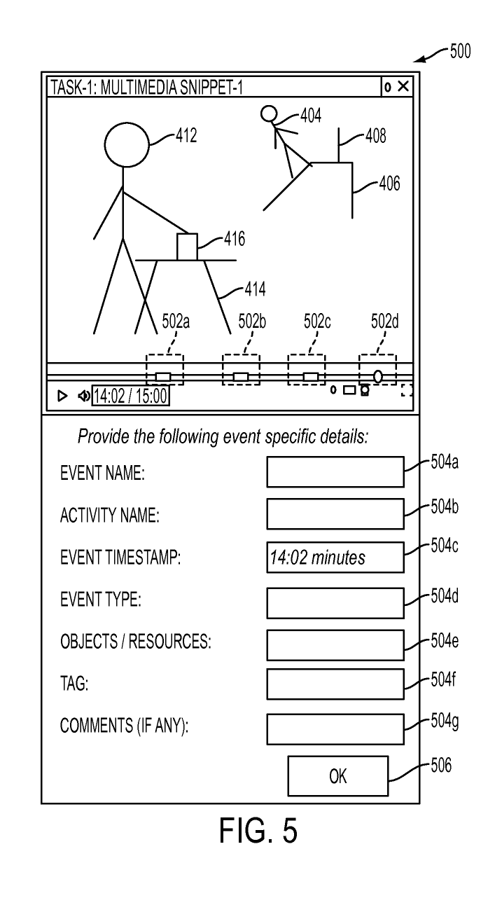

The user-interfaces 402 and 410 depict two snapshots of the second multimedia content being played on a media player software on the worker-computing device 114. For instance, assuming the second multimedia content to be an animation of 30 seconds length, the user-interface 402 (of FIG. 4A) shows a snapshot of the second multimedia content at 12 seconds (of 30 seconds), while the user-interface 410 (of FIG. 4B) shows a snapshot of the second multimedia content at 18 seconds (of 30 seconds). As shown in FIG. 4A, the snapshot illustrated in the user-interface 402 depicts a resource 404 climbing up a ramp 406. An object 408 stands vertically atop the ramp 406. Hence, the worker may understand that the first multimedia content may include one or more events related to the resource 404 climbing up the ramp 406 and using the object 408. Further, as shown in FIG. 4B, the snapshot illustrated in the user-interface 410 depicts a resource 412 approaching an object 416 lying on a table 414, for applying force on the object 416 or picking up the object 416. Hence, the worker may understand that the first multimedia content may also include one or more events related to the resource 412 going towards the object 416 placed on the table 414, and applying force on the object 416 or picking up the object 416, and so on. The worker may not as such be cognizant of such events in the first multimedia content. However, when a multimedia snippet (of the one or more multimedia snippets in the first multimedia content) is presented to the worker as a crowdsourcing task, the worker may identify the one or more events in the multimedia snippet, based on the second multimedia content presented to the worker. An example user-interface presented on the worker-computing device 114 to display the multimedia snippet to the worker and receive the worker's inputs pertaining to the identification of the one or more events is explained in conjunction with FIG. 5.

A person skilled in the art would appreciate that the user-interfaces 402 and 410 are examples for illustrative purposes, which should not be construed to limit the scope of the disclosure.

FIG. 5 illustrates an example user-interface 500 that may be presented on the worker-computing device 114 to display the first multimedia content to the worker and receive inputs pertaining to an identification of one or more events in the first multimedia content, in accordance with at least one embodiment.

As shown in FIG. 5, the user-interface 500 depicts a crowdsourcing task (Task-1) being presented to the worker. The crowdsourcing task (Task-1) includes a Multimedia Snippet-1 from the one or more multimedia snippets of the first multimedia content. The Multimedia Snippet-1 may be played on a media player software of the worker-computing device 114. For instance, assuming that the Multimedia Snippet-1 is of 15 minutes length, the user-interface 500 shows a snapshot of the Multimedia Snippet-1 at 14:02 minutes (of 15 minutes). Further, FIG. 5 shows a seek bar 502d of the media player software located at a position of 14:02 minutes from 15:00 minutes representing a location of the current snapshot in the Multimedia Snippet-1. For instance, the current snapshot of the Multimedia Snippet-1 depicts the resource 412 picking up the object 416 from the table 414. Further, the current snapshot depicts that the resource 404 has reached the top of the ramp 406, while the object 408 is placed atop the ramp 406.

Markers 502a, 502b, and 502c denote locations of snapshots in the Multimedia Snippet-1, where the worker identified one or more events in the Multimedia Snippet-1. The worker may identify an event in the current snapshot of the Multimedia Snippet-1 (at a location depicted by the seek bar 502d) by providing inputs in various textboxes 504a, 504b, 504c, 504d, 504e, 504f, 504g and pressing an OK button 506. For instance, the worker may identify an event (e.g., the resource 412 picking up the object 416 or the resource 404 reaching the top of the ramp 406) and provide various inputs such as an event name, an activity name, an event timestamp (which may be same as the location of the current snapshot in the Multimedia Snippet-1, e.g., 14:02 minutes), an event type, objects/resources involved, a tag for the event, and comments through the textboxes 504a-504g, respectively. A person skilled in the art would appreciate that the worker may identify more than one events in a single snapshot of the Multimedia snippet-1 without departing from the scope of the disclosure.

A person skilled in the art would appreciate that the user-interface 500 is an example for illustrative purposes, which should not be construed to limit the scope of the disclosure.

Various embodiments of the disclosure encompass numerous advantages including creation of a log of one or more events from a first multimedia content capturing one or more activities related to the one or more events. The first multimedia content is crowdsourced to a first set of workers for identification of the one or more events. Further, the first set of workers may be provided with a second multimedia content, such as an animation illustrative of the one or more events, which may be used by the first set of workers to identify the one or more events. Hence, the first set of workers need not as such be cognizant of the one or more events, prior to receiving the second multimedia content. Therefore, the disclosure may be implemented for identification of even complex events, such as one or more operations involved in a surgical procedure, one or more business processes involved in an organization, or manufacturing processes involved in a manufacturing firm.

Further, prior to crowdsourcing the first multimedia content, various entities in the first multimedia content, which include private/confidential information, are masked. The masking of such entities may preserve privacy and confidentiality of the organization and/or the entities by not revealing the identity of the organization/entities to the first set of workers. Thus, the disclosure provides for a privacy preserving solution for identification of the one or more events by the first set of workers, who may be such in cognizant of the one or more events.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for creating a log of one or more events through crowdsourcing have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A system for creating a log of one or more events in a first multimedia content, the system comprising:
a transceiver configured to transmit said first multimedia content and a second multimedia content to a first set of workers, wherein said first set of workers utilize said second multimedia content to identify said one or more events in said first multimedia content; and
one or more processors configured to create said log of said one or more events, identified by said first set of workers, based on at least temporal occurrence of said one or more events in said first multimedia content.

2. The system of claim 1, wherein said first set of workers are incognizant of said one or more events.

3. The system of claim 1, wherein said second multimedia content corresponds to an animation illustrative of said one or more events.

4. The system of claim 1 further comprising an image processor configured to segregate said first multimedia content in one or more multimedia snippets.

5. The system of claim 1 further comprising an image processor configured to identify one or more entities, representative of confidential/private information, in said first multimedia content.

6. The system of claim 5, wherein said image processor is further configured to track said one or more entities in the said first multimedia content.

7. The system of claim 5, wherein said transceiver is further configured to receive an input from a second set of workers, and wherein said input corresponds to identification of said one or more entities in said first multimedia content.

8. The system of claim 5, wherein said image processor is further configured to mask said one or more entities in said first multimedia content to hide said confidential/private information.

9. The system of claim 1 further comprising an image processor configured to mark one or more objects of interest in said first multimedia content.

10. The system of claim 9, wherein said transceiver is further configured to receive an input from a second set of workers, and wherein said input corresponds to marking of said one or more objects of interest.

11. The system of claim 9, wherein said image processor utilizes an object matching software to mark said one or more objects of interest.

12. The system of claim 11, wherein said image processor is further configured to track said one or more objects of interest in the said first multimedia content.

13. The system of claim 12, wherein said one or more events correspond to at least one or more activities involving said one or more objects of interest.

14. The system of claim 1, wherein said first multimedia content relates to at least a process or a workflow associated with an organization.

15. The system of claim 1, wherein said log comprises one or more attributes associated with each of said one or more events.

16. The system of claim 15, wherein said one or more attributes comprise at least one of a timestamp associated with an event, a tag associated with said event, a type of said event, one or more objects of interest involved in an activity associated with said event, or an identification of said event.

17. A method for creating a log of one or more events in a first multimedia content, the method comprising:
transmitting, by a transceiver, said first multimedia content and a second multimedia content to a first set of workers, wherein said first set of workers utilize said second multimedia content to identify said one or more events in said first multimedia content; and
creating, by one or more processors, said log of said one or more events, identified by said first set of workers, based on at least temporal occurrence of said one or more events in said first multimedia content.

18. The method of claim 17 further comprising segregating, by an image processor, said first multimedia content in one or more multimedia snippets.

19. The method of claim 17 further comprising identifying, by an image processor, one or more entities, representative of confidential/private information, in said first multimedia content.

20. The method of claim 19 further comprising tracking, by said image processor, said one or more entities in the said first multimedia content.

21. The method of claim 19 further comprising receiving, by said transceiver, an input from a second set of workers, and wherein said input corresponds to identification of said one or more entities in said first multimedia content.

22. The method of claim 19 further comprising masking, by said image processor, said one or more entities in said first multimedia content to hide said confidential/private information.

23. The method of claim 17 further comprising marking, by an image processor, one or more objects of interest in said first multimedia content.

24. The method of claim 23 further comprising receiving, by said transceiver, an input from a second set of workers, and wherein said input corresponds to marking of said one or more objects of interest.

25. The method of claim 23, wherein said image processor utilizes an object matching software to mark said one or more objects of interest.

26. The method of claim 25 further comprising tracking, by said image processor, said one or more objects of interest in the said first multimedia content.

27. The method of claim 26, wherein said one or more events correspond to at least one or more activities involving said one or more objects of interest.

28. The method of claim 17, wherein said log comprises one or more attributes associated with each of said one or more events.

29. The method of claim 28, wherein said one or more attributes comprise at least one of a timestamp associated with an event, a tag associated with said event, a type of said event, one or more objects of interest involved in an activity associated with said event, or an identification of said event.

30. A method for determining a compliance of an execution of one or more processes/workflows in an organization, the method comprising:
receiving, by a transceiver, a first multimedia content related to said execution of said one or more processes/workflows;
transmitting, by said transceiver, said first multimedia content and a second multimedia content to a first set of workers, wherein said first set of workers utilize said second multimedia content to identify one or more events, associated with said processing of said execution of said one or more processes/workflows, in said first multimedia content;
creating, by one or more processors, a log of said one or more events, identified by said first set of workers, based on at least temporal occurrence of said one or more events in said first multimedia content;
comparing, by a comparator, said log with a predetermined standard of said execution of said one or more processes/workflows; and
determining, by said one or more processors, said compliance of said execution of said one or more processes/workflows based on said comparison.

31. A computer program product for use with a computing device, the computer program product comprising a non-transitory computer readable medium, the non-transitory computer readable medium stores a computer program code for creating a log of one or more events in a first multimedia content, the computer program code is executable by one or more processors in the computing device to:
transmit, by a transceiver, said first multimedia content and a second multimedia content to a first set of workers, wherein said first set of workers utilize said second multimedia content to identify said one or more events in said first multimedia content; and
create, by said one or more processors, said log of said one or more events, identified by said first set of workers, based on at least temporal occurrence of said one or more events in said first multimedia content.
